(19) United States
(12) Patent Application Publication
(10) Pub. No.: US 2011/0067241 A1
(43) Pub. Date: Mar. 24, 2011

(54) NOSE HAIR TRIMMER

(75) Inventors: Hitoshi Ogawa, Inukami (JP); Yasuo Uenishi, Omihachiman (JP)

(73) Assignee: Panasonic Electric Works Co., LTD., Osaka (JP)

(21) Appl. No.: 12/881,305

(22) Filed: Sep. 14, 2010

(30) Foreign Application Priority Data
Sep. 18, 2009 (JP) 2009-217732

(51) Int. Cl. B26B 19/00

(52) U.S. Cl. 30/29.5

(57) ABSTRACT

A nose hair trimmer that can be washed with a washing liquid without removing a blade unit from the trimmer. The nose hair trimmer, which improves washability, includes a main body case including an interior cavity, which accommodates a rotational inner blade body and collects nose hair clippings, and a disposal port, which communicates the cavity with the exterior. The rotational inner blade body includes an inner blade base, which supports inner blades and has two holding pieces functioning as vanes. Rotation of the rotational inner blade body rotates the holding pieces and produces a flow of washing liquid directed from slits in an outer blade via the interior cavity and toward the disposal port. The washing liquid washes the interior cavity and discharges nose hair clipping from the nose hair trimmer.

### BACKGROUND OF THE INVENTION

The present invention relates to a nose hair trimmer having a washable structure.

Japanese Patent No. 4203670 describes an example of a nose hair trimmer insertable into a user's nostril to trim nose hair. Such a nose hair trimmer includes an outer blade (fixed blade), an inner blade (movable blade), and a motor. The outer blade is cylindrical and suitable for insertion into a nostril. The inner blade is rotated inside the outer blade by the motor, which is arranged in a main body of the nose hair trimmer. The nose hair trimmer further includes a receptacle for accommodating the inner blade. The inner blade receptacle is also used to collect nose hair clippings. The user removes the collected nose hair clippings from the main body at an appropriate timing to keep the nose hair trimmer clean.

The inner blade and an inner blade support, which is joined with the inner blade, have complicated shapes. This makes it difficult and burdensome to sufficiently remove the nose hair clippings from the inner blade and inner blade support even when using a brush or the like, which is provided as an accessory for the nose hair trimmer.

The blades and their peripheral components may be disassembled so that they can be cleaned with a washing liquid such as water. However, the inner blade and inner blade support are sharp and relatively small components. Thus, such components are difficult to handle and causes disassembly and washing to be burdensome.

It is thus desirable that a washing liquid such as water be drawn into the nose hair trimmer with the blades left in the nose hair trimmer when cleaning the nose hair trimmer. However, it is still difficult to clean the nose hair trimmer just by pouring water into the nose hair trimmer. Thus, improvements must be made to solve this problem.

It is an object of the present invention to provide a nose hair trimmer that allows for washing with the blades left in the nose hair trimmer while improving the washability of the nose hair trimmer.

One aspect of the present invention is a nose hair trimmer including a case, an outer blade, a rotational inner blade body, and a drive source. The outer blade includes an opening and is supported by the case. The rotational inner blade body including an inner blade, which is accommodated in the outer blade, and an inner blade base, which supports the inner blade. The drive source rotates the rotational inner blade body to clip nose hair between the outer blade and the inner blade. The case includes an interior cavity, which accommodates the rotational inner blade body and collects nose hair clippings, and a disposal port, which communicates the interior cavity with the exterior. The inner blade base includes a vane. Rotation of the rotational inner blade body rotates the vane and forms a liquid flow path connecting the opening of the outer blade, the interior cavity, and the disposal port. Liquid is circulated through the flow path to wash the interior cavity.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1(a) and 1(b) are perspective views showing a nose hair trimmer according to one embodiment of the present invention;

FIG. 2 is an exploded view showing a blade unit of the nose hair trimmer;

FIG. 3 is a cross-sectional view showing the blade unit and its surrounding in the nose hair trimmer;

FIGS. 4(a) and 4(b) are explanatory diagrams showing a disposal port of the nose hair cuter;

FIGS. 5(a) and 5(b) are explanatory views showing washing examples of the nose hair trimmer; and

FIGS. 6(a) and 6(b) are explanatory views showing modifications of the disposal port in the nose hair trimmer.

### DETAILED DESCRIPTION OF THE PREFERRED EMBODIMENTS

A nose hair trimmer 10 according to one embodiment of the present invention will now be discussed with reference to the drawings.

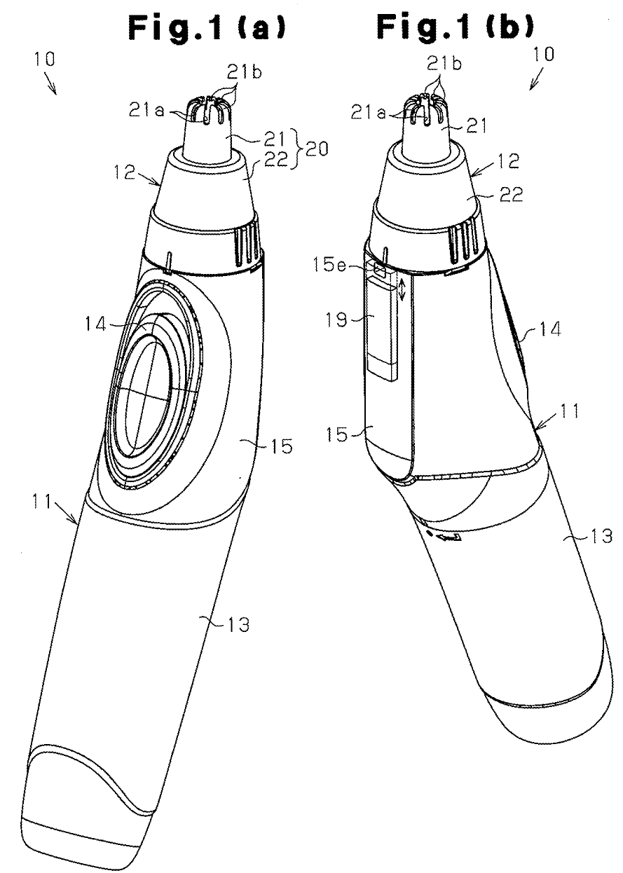

As shown in FIG. 1, the nose hair trimmer 10, which is elongated and cylindrical, includes a main body 11 and a blade unit 12. The main body 11 is formed so as to allow for gripping by a user. The blade unit 12 is arranged on a distal end (one of the longitudinal ends) of the main body 11. A handle 13 having a form enabling easy gripping is arranged at a basal end (the other one of the longitudinal ends) of the main body 11. A slide switch 14 is arranged next to the handle 13 at a central part of the main body 11. The switch 14 is attached to a main body case 15, which forms an outer shell of the main body 11 and has a waterproof structure.

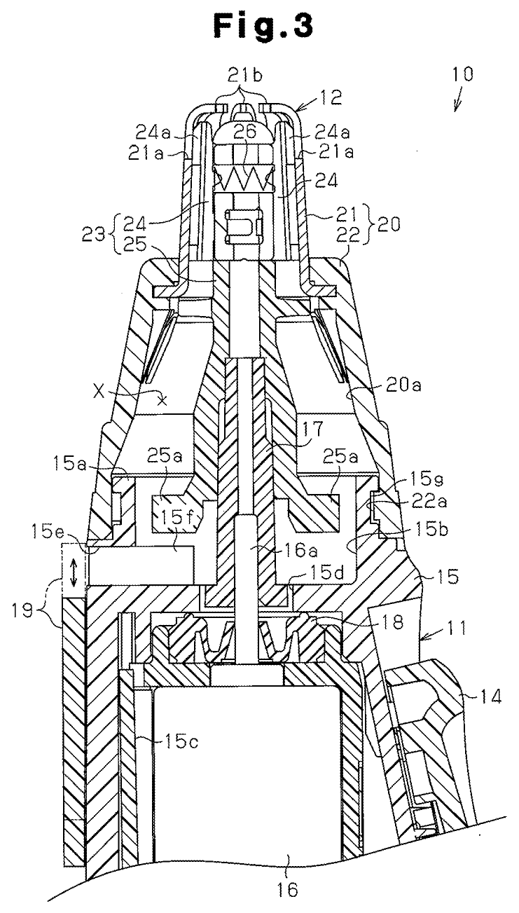

Referring to FIG. 3, the main body 11 (main body case 15) accommodates a drive motor 16. More specifically, the motor 16 is arranged in the central part of the main body 11 (inward from the switch 14) so that a rotary shaft 16a of the motor 16 extends in the longitudinal direction of the main body 11. A battery (not shown) that supplies the drive motor 16 with power is arranged in the handle 13 of the main body 11. When the switch 14 is turned on, the battery supplies the drive motor 16 with drive power.

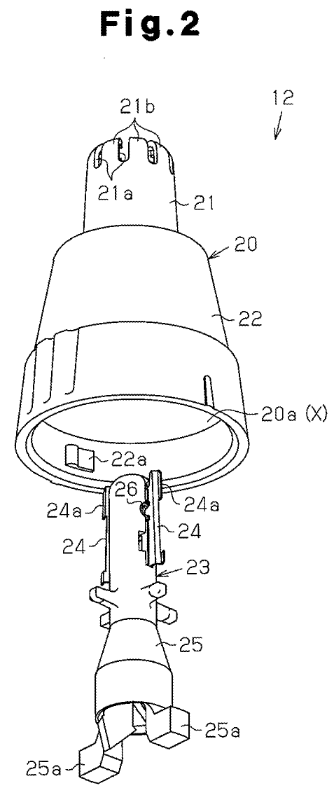

The rotary shaft 16a of the drive motor 6 projects from a distal end of the main body 11 at which the blade unit 12 is arranged. A joint 17 is fitted to and fixed to the rotary shaft 16a. The rotary shaft 16a is formed from metal, and the joint 17 is formed from resin. The joint 17 has a distal portion on which a rotational inner blade body 23, which forms part of the blade unit 12, is attached. The rotational inner blade body 23 is removable from and integrally rotatable with the joint 17. Referring to FIG. 2, the blade unit 12 includes an outer blade body 20 and the rotational inner blade body 23. The outer blade body 20 includes an outer blade frame 22 and an outer blade 21 (fixed blade), which is mounted on the outer blade frame 22. The inner blade body 23 includes an inner blade base 25 and inner blades 24 (movable blade), which are mounted on the inner blade base 25.

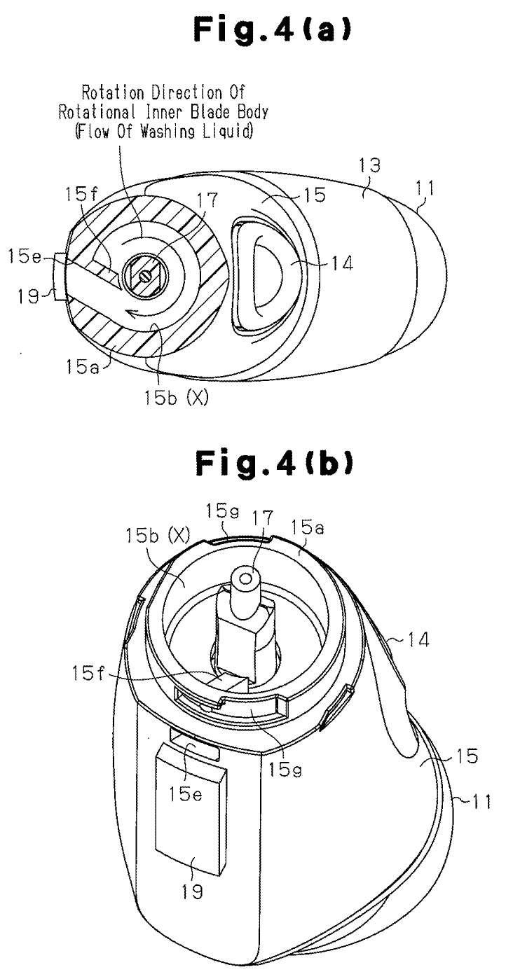

Referring to FIGS. 3 and 4, an annular mount 15a is formed in the distal part of the main body case 15. The outer blade frame 22 is fitted onto the mount 15a. A pit 15b having a depth that is slightly greater than the height of the mount 15a is defined inside the mount 15a. The pit 15b is in communication with an inner blade receptacle 20a, which is formed inside the outer blade body 20, and defines an interior cavity X. The interior cavity X functions as a region in which nose hair clippings are collected.

The pit 15b has a bottom surface functioning to partition the pit 15b from a motor retaining compartment 15c, which retains the drive motor 16. An insertion hole 15d extends through the center of the bottom surface to project the rotary shaft 16a and the joint 17 into the interior cavity X. An M-shaped seal 18, which seals a gap between the rotary shaft 16a of the drive motor 16 and the main body case 15, is arranged in the motor retaining compartment 15c near the insertion hole 15d. The seal 18 prevents foreign matter in the interior cavity X, such as nose hair clippings and washing liquid, from moving toward the rotary shaft 16a and the drive motor 16 through the insertion hole 15d.

A disposal port 15e, which is in communication with the pit 15b, is arranged near the mount 15a of the main body case 15. The disposal port 15e is connected with the interior cavity X. Further, the disposal port 15e opens outward at a location separated by 180° from the switch 14. That is, the disposal port 15e and the switch 14 are located on opposite sides of the main body case 15. A lid 19, which is movable on the outer surface of the main body case 15, opens and closes the disposal port 15e.

The disposal port 15e, which has a tetragonal opening, includes a bottom surface that is flush with the bottom surface of the pit 15b. A plan view of the pit 15b (refer to FIG. 4(a)) shows a guide wall 15f extending toward the joint 17 from a side wall of the disposal port 15e. The guide wall 15f has a height that is about the same as that of the disposal port 15e. The guide wall 15f is formed so as to connect part of an inner circumferential surface of the mount 15a to part of the bottom surface of the pit 15b. Further, the guide wall 15f extends from an open edge of the disposal port 15e to the vicinity of the outer surface of the joint 17. Thus, the guide wall 15f is formed integrally with the side wall of the disposal port 15e so that liquid flowing through the pit 15b in the clockwise direction, as viewed in FIG. 4, is guided to the opening of the disposal port 15e. The clockwise direction is the rotation direction of the rotational inner blade body 23 and the direction in which liquid circles the interior cavity X along the inner wall surface of the pit 15b. Accordingly, the guide wall 15f is flush with the side wall of the disposal port 15e and does not include any steps in between. Further, the guide wall 15f and the side wall of the disposal port 15e are sloped radially outward relative to the clockwise direction as viewed in FIG. 4.

Referring to FIGS. 2 and 3, the blade unit 12 includes the outer blade body 20 and the rotational inner blade body 23. The outer blade body 20 includes the outer blade frame 22 and the outer blade 21, which is mounted on the outer blade frame 22. The rotational inner blade body 23 includes the inner blade base 25 and the inner blades 24, which are mounted on the inner blade base 25.

The outer blade 21, which is cylindrical and suitable for insertion into the user's nostril, is fixed to the distal portion of the outer blade frame 22. The basal portion of the outer blade frame 22 is fitted onto the mount 15a, which is arranged on the distal portion of the main body 11 (main body case 15). Two tabs 22a, which are located at opposing positions separated by 180° from each other, are formed on the inner surface in the basal portion of the outer blade frame 22. Two grooves 15g are formed in the outer surface of the mount 15a of the main body 11 in correspondence with the two tabs 22a. The outer blade frame 22 is rotated to engage the tabs 22a with the grooves 15g. This mounts the outer blade frame 22 (outer blade body 20) onto the mount 15a in a removable manner.

The outer blade 21 is cylindrical and has a distal end that is bent slightly inward. More specifically, the outer blade 21 includes a plurality of teeth 21b, each having a distal end that is bent toward the center of the distal end face of the outer blade 21. The teeth 21b are formed by a plurality of slits 21a, or openings, extending radially from the center of the distal end face of the outer blade 21 toward the side surface of the outer blade 21. The inner side of the outer blade body 20 forms the inner blade receptacle 20a, which rotatably retains the rotational inner blade body 23.

The rotational inner blade body 23 includes the inner blade base 25 and two inner blades 24, which are formed by metal plates and attached to the distal outer surface of the inner blade base 25 at opposing positions separated by 180° from each other. The joint 17 couples the inner blade base 25 to the rotary shaft 16a of the motor 16. The rotational inner blade body 23 is arranged in the inner blade receptacle 20a of the outer blade body 20. A spring 26 produces urging force that presses a cutting edge 24a of each inner blade 24 against the inner surface of the outer blade 21.

During use, the switch 14 is turned on to drive the motor 16. This rotates the rotary shaft 16a together with the rotational inner blade body 23 and clips nose hair between the outer blade 21 and the cutting edges 24a of the inner blades 24. Nose hair clippings are collected in the interior cavity X, which is formed by the pit 15b and the inner blade receptacle 20a. The nose hair trimmer 10 is normally used with its outer blade 21 facing upward. This collects many clippings in the pit 15b. During use, the disposal port 15e is closed by the lid 19 so that nose hair clippings do not fall out from the disposal port 15e.

The inner blade base 25 includes two holding pieces 25a, which are arranged at the basal portion of the inner blade base 25 at opposing positions separated by 180° from each other. Each holding piece 25a extends from the basal end of the inner blade base 25 in a direction perpendicular to the axial direction of the inner blade base 25 (i.e., axial direction of the rotary shaft 16a). Thus, the two holding pieces 25a extend linearly and radially outward in opposite directions. Each holding piece 25a has a tetragonal cross-section. More specifically, the tetragonal cross-section of each holding piece 25a is formed by two sides extending in a direction perpendicular to the axial direction of the rotary shaft 16a and two sides extending along the axial direction of the rotary shaft 16a. The holding pieces 25a are each shaped so that a user or a person assembling the nose hair trimmer 10 can easily hold the holding pieces 25a with his or her fingers when handling the inner blade base 25 (rotational inner blade body 23).

The two holding pieces 25a arranged on the inner blade base 25 function as vanes when rotated together with the rotational inner blade body 23. More specifically, when the rotational inner blade body 23 (inner blade base 25) is attached to the joint 17, the holding pieces 25a are arranged so that the top surface of the disposal port 15e in the main body case 15 is located slightly below the basal end of the holding pieces 25a. Due to such a positional relationship between the holding pieces 25a and the disposal port 15e, rotation of the rotational inner blade body 23 rotates the holding pieces 25a and forms a fluid path directed from the slits 21a of the outer blade 21 via the interior cavity X and toward the disposal port 15e.

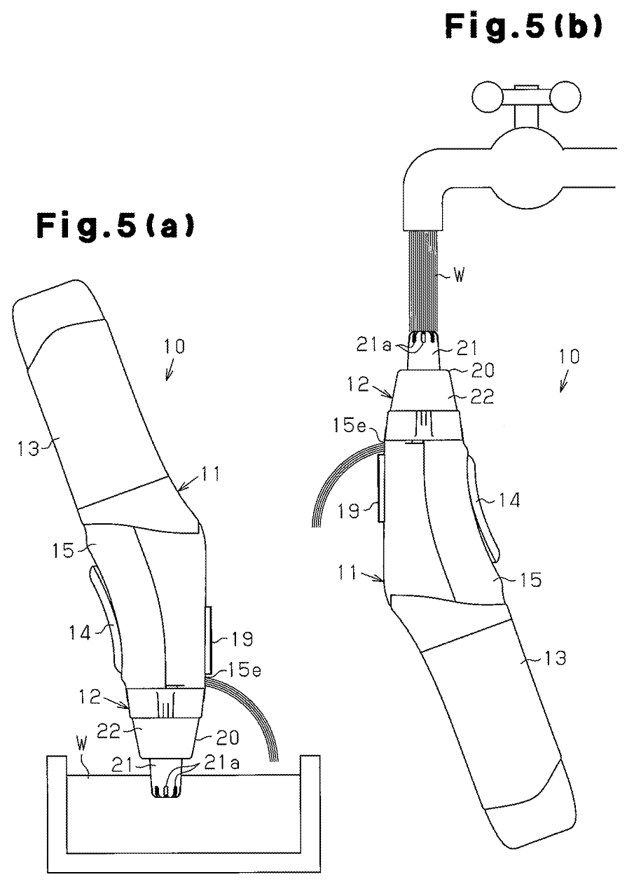

Referring to FIG. 5(b), the lid 19 is operated to open the disposal port 15e, which is closed during use. Then, the outer blade 21 is directed upward and washing liquid, for example, tap water W serving as a washing liquid is poured into the outer blade 21. The water W enters the interior cavity X through the slits 21a of the outer blade 21. This cleans the interior cavity X, and the nose hair clippings collected in the blade unit 12 are disposed of from the disposal port 15e. In this state, the nose hair trimmer 10 is driven to rotate the rotational inner blade body 23 while washing the nose hair trimmer 10. This produces a strong flow of water directed from the slits 21a of the outer blade 21 via the interior cavity X and toward the disposal port 15e. As a result, nose hair clippings are discharged out of the blade unit 12 in a further preferable manner together with the tap water W.

When cleaning the nose hair trimmer 10 while rotating the rotational inner blade body 23, a strong flow of water is produced in the blade unit 12. Thus, by directing the outer blade 21 downward as shown in FIG. 5(a), washing liquid (e.g., tap water W) is drawn into the nose hair trimmer 10 and discharged out of the disposal port 15e to clean the interior of the blade unit 12. The washing liquid is not limited to tap water W. For example, a liquid mixed with a chemical agent that is suitable for cleaning may be used as the washing liquid.

The nose hair trimmer 10 of the present embodiment has the advantages described below.

(1) The main body case 15 of the nose hair trimmer 10 includes the interior cavity X and the disposal port 15e. The interior cavity X accommodates the rotational inner blade body 23, which includes the inner blades 24, and collects nose hair clippings. The disposal port 15e communicates the interior cavity X with the exterior of the nose hair trimmer 10. The inner blade base 25, which supports the inner blade 24, includes the two holding pieces 25a, which function as vanes. Rotation of the rotational inner blade body 23 rotates the vanes (holding pieces 25a). This produces a flow of the washing liquid (water W) directed from the slits 21a of the outer blade 21 via the interior cavity X and toward the disposal port 15e. Foreign matter such as nose hair clippings are disposed of together with the washing liquid from the nose hair trimmer 10. In this matter, flowing water is not just poured into the nose hair trimmer 10. Rather, a strong flow of the washing liquid is produced in the nose hair trimmer 10 by the rotation of the vanes (holding pieces 25a). This improves the washability.

(2) In the present embodiment, the disposal port 15e is arranged near the holding pieces 25a (vanes), as shown in FIG. 3. Thus, the flow of the washing liquid remains strong when discharged out of the nose hair trimmer 10. This improves the washability.

(3) The holding pieces 25a of the inner blade base 25 are held with the fingers or the like by a user or a person assembling the nose hair trimmer 10 when handling the rotational inner blade body 23. In addition, the holding pieces 25a also function as vanes. This simplifies the structure and reduces the size of the inner blade base 25 (rotational inner blade body 23) thereby contributing to reducing the overall size of the nose hair trimmer 10.

(4) The two holding pieces 25a extend radially outward in opposite directions. This allows for a user to easily hold the inner blade base 25 (rotational inner blade body 23) with the holding pieces 25a. Further, the holding pieces 25a efficiently produce a flow of liquid.

(5) The main body case 15 includes the lid 19, which opens and closes the disposal port 15e. Thus, by closing the disposal port 15e during use, nose hair clippings are prevented from falling out from the disposal port 15e.

(6) The disposal port 15e and the switch 14 are arranged on opposite sides of the nose hair trimmer 10. Thus, when a user operates the switch 14 with his or her fingers to perform washing, the user's fingers do not touch the washing liquid discharged from the disposal port 15e. This facilitates washing.

(7) The guide wall 15f is arranged to face toward a flow of washing liquid (water W) and guides the washing liquid (water W) to the disposal port 15e. Thus, the washing liquid that circles the interior cavity X along the inner surface of the pit 15b is efficiently discharged from the disposal port 15e together with foreign matter such as nose hair clippings. This improves the washability. Further, the guide wall 15f facing toward the water flow is flush with side wall of the disposal port 15e. This reduces the resistance applied to the washing liquid (flow resistance). In addition, the guide wall 15f and the side wall of the disposal port 15e are sloped radially outward with respect to the direction in which liquid flows as it circles the interior cavity X. This reduces the resistance applied to the washing liquid (flow resistance) and improves the washability.

It should be apparent to those skilled in the art that the present invention may be embodied in many other specific forms without departing from the spirit or scope of the invention. Particularly, it should be understood that the present invention may be embodied in the following forms.

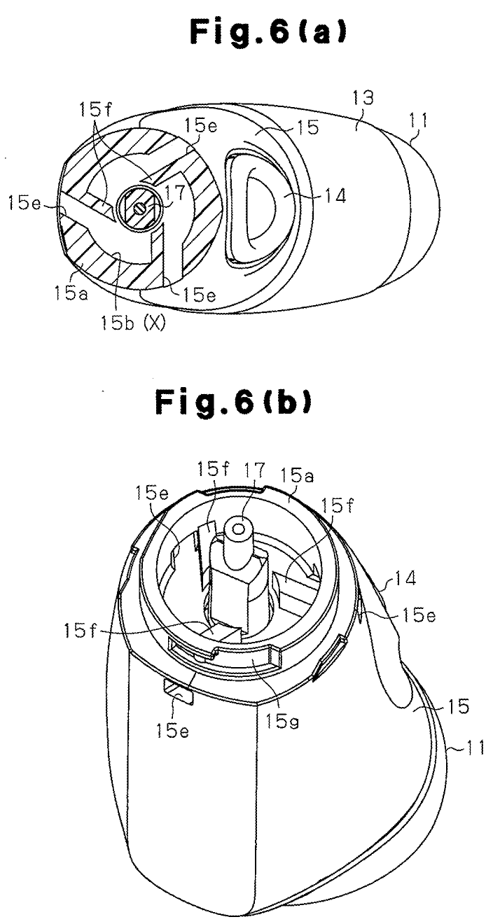

Instead of just one disposal port 15e, there may be more than one disposal port 15e. For example, as shown in FIG. 6, there may be three disposal ports 15e arranged at equal angular intervals. In the example shown in FIG. 6, each of the disposal ports 15e includes the guide wall 15f in the same manner as in the above-discussed embodiment. Further, as shown in FIG. 6, the lid 19 for opening and closing the disposal port 15e may be eliminated.

In the above-discussed embodiment, the disposal port 15e and the switch 14 are arranged on opposite sides of the nose hair trimmer 10. However, the location of the disposal port 15e may be changed as required. Further, the location of the disposal port 15e in the longitudinal direction (vertical direction) is not limited to the position shown in FIG. 3. For example, the disposal port 15e may be arranged so as to overlap with the holding pieces 25a, which function as the vanes, and the disposal port 15e.

The holding pieces 25a used to hold the inner blade base 25 (rotational inner blade body 23) also function as the vanes. However, the inner blade base 25 may include holding pieces used just to hold the inner blade base 25. Further, the holding pieces 25a may be flap-shaped. The flap shape may be set to draw in liquid from the disposal port 15e and reverse the flow of liquid from the above-discussed embodiment when perform washing.

The side wall of the disposal port 15e does not have to be flush with the guide wall 15f. For example, the guide wall 15f may be arranged at a position separated from the disposal port 15e in the clockwise direction by a predetermined angle (angle smaller than 180°). Further, the side wall of the disposal port 15e and the guide wall 15f extend straight along the same plane but may be curved instead. In another example, either one of the side walls of the disposal port 15e and the guide wall 15f may be sloped. In this case, the disposal port 15e extends in the radial direction. The guide wall 15f may also be eliminated.

Instead of the main body case 15, the disposal port 15e may be formed in the blade unit 12 (outer blade frame 22).

The lid 19 that opens and closes the disposal port 15e is not limited to a type that slides in the longitudinal direction (vertical direction) and may be of a rotational type.

The present examples and embodiments are to be considered as illustrative and not restrictive, and the invention is not to be limited to the details given herein, but may be modified within the scope and equivalence of the appended claims.

What is claimed is:

1. A nose hair trimmer comprising:
a case;
an outer blade including an opening and supported by the case;
a rotational inner blade body including an inner blade, which is accommodated in the outer blade, and an inner blade base, which supports the inner blade; and
a drive source that rotates the rotational inner blade body to clip nose hair between the outer blade and the inner blade;
the case including:
an interior cavity that accommodates the rotational inner blade body and collects nose hair clippings; and
a disposal port communicating the interior cavity with the exterior; and
the inner blade base including a vane;
wherein rotation of the rotational inner blade body rotates the vane and forms a liquid flow path connecting the opening of the outer blade, the interior cavity, and the disposal port, with liquid circulated through the flow path to wash the interior cavity.

2. The nose hair trimmer according to claim 1, wherein the disposal port is arranged near the vane.

3. The nose hair trimmer according to claim 1, wherein the vane is arranged on the inner blade base and includes a holding piece used to hold the inner blade base.

4. The nose hair trimmer according to claim 3, wherein the holding piece is one of two holding pieces extending from the inner blade base in opposite directions perpendicular to a rotational axis direction of the inner blade base.

5. The nose hair trimmer according to claim 1, further comprising:
a lid arranged on the case to open and close the disposal port.

6. The nose hair trimmer according to claim 1, further comprising:
a switch arranged on the case to drive and stop the drive source, wherein the disposal port and the switch are arranged on opposite sides of the case.

7. The nose hair trimmer according to claim 1, wherein the case includes:
an outer blade frame that fixes the outer blade and includes an inner blade receptacle, which accommodates the rotational inner blade body; and
a mount onto which the outer blade frame is mounted;
wherein the mount includes a pit that is in communication with the disposal port, and the inner blade receptacle and the pit form the interior cavity.

8. The nose blade trimmer according to claim 7, wherein the vane is arranged upward from the disposal port in the pit.
